(19) United States
(12) Patent Application Publication
(10) Pub. No.: US 2012/0019366 A1
(43) Pub. Date: Jan. 26, 2012

(54) DETERMINING A COMMUNICATION STATE OF A CABLE SUBSYSTEM

(76) Inventor: Jerry Aguren, Tomball, TX (US)

(21) Appl. No.: 13/260,290

(22) PCT Filed: Jan. 15, 2010
(86) PCT No.: PCT/US10/21228

§ 371 Date: Sep. 24, 2011

(51) Int. Cl. G06K 7/01

(52) U.S. Cl. 340/10.1

(57) ABSTRACT

A handheld or portable reader is operable to read, from a memory associated with an integrated circuit (IC) device of a cable communication subsystem, data associated with at least one physical layer characteristic related to quality of communication performance of the subsystem, and to process the physical layer characteristic data to determine a communication state of the cable communication subsystem.

### FIELD OF THE INVENTION

The invention relates to determining a communication state of a cable subsystem.

### BACKGROUND

Networking infrastructures such as data centers house large numbers of electronic equipment, such as computers and storage devices. Such networking infrastructures can span from a single room to multiple floors of an entire building. Servers are often stacked in rack cabinets that are placed in rows forming corridors so technicians can access the rear of each cabinet. Mainframe computers and other storage devices are often placed near the servers and can occupy spaces as large as the racks themselves.

Data centers and other networking infrastructures can have enormous numbers of cable and wires connecting various electronic equipments. Even though such facilities are highly organized, the number of cables interconnecting such equipment can be overwhelming. Installing, maintaining, and tracking cables and connections to equipment, can be complex. Identifying a type of fault and the cable subsystem component(s) involved, for example if a cable or transceiver of a cable subsystem becomes degraded or experiences a critical failure, can also be problematic in such environments.

### SUMMARY OF THE INVENTION

One example embodiment is a handheld or portable reader that reads, from a memory associated with an integrated circuit (IC) device of a cable communication subsystem, data associated with at least one physical layer characteristic related to quality of communication performance of the subsystem. The reader processes the physical layer characteristic data to determine a communication state of the cable communication subsystem.

### BRIEF DESCRIPTION OF THE DRAWINGS

In order that the invention may be well understood, various embodiments thereof will now be described, by way of example only, with reference to the accompanying drawings, in which:

FIG. 1 is a schematic diagram of a communication cable subsystem comprising a cable and two transceivers;

FIG. 2 is a representation showing functional elements of an integrated circuit device attached to the cable;

FIG. 3 is a representation showing functional elements of an integrated circuit device attached to a transceiver;

FIG. 4 is an external front view showing elements of a handheld reader;

FIG. 5 is a representation showing functional elements of the reader; and

FIG. 6 is a flow diagram illustrating an exemplary method to determine a present communication state of a cable subsystem.0

Drawings are schematic and not to scale.

### DETAILED DESCRIPTION

Various embodiments of the invention relate to a portable or handheld reader operable to read data from a memory of a cable communication subsystem, for example a fiber optic cable subsystem in a data center. In some embodiments, the cable communication subsystem comprises a cable having cable end connectors at opposite ends thereof, the end connectors plugged into respective communication signal transceivers, the end connectors and transceivers including respective integrated circuit (IC) devices including RFID transponders providing a low power, low frequency, cable subsystem monitoring and/or diagnostic channel. In some embodiments, the memory is provided by one or more of the IC devices.

In at least some embodiments, memory attached to the cable, for example in at least one of the end connector IC device, stores data relating to the cable. Such cable data can comprise cable-related parameters of physical layer characteristics, for example: cable serial number, fiber or conductor type, fiber or conductor length, core diameter, connector type, and attenuation data for one or more fibers or conductors of the cable. At least some of the cable data can be stored to the cable attached memory, for example, during cable assembly. The transceiver dynamically collects and stores data relating to the transceiver in a memory of the transceiver, for example in memory provided by the transceiver IC device. Such transceiver data comprises transceiver-related parameters of physical layer characteristics, for example: transceiver serial number, transceiver type, and/or performance data relating to quality of communication, such as optical transmit power and/or optical receiver power. In some embodiments, transceivers and connectors can also be adapted to dynamically provide cable attenuation data, for example from an optical time domain reflectometer (OTDR) embedded in a transceiver, or connector engagement status (examples: connector fully engaged, partially engaged or not engaged).

In some embodiments, the connector and transceiver IC devices are adapted to exchange data when interconnected, so that the cable data and also the transceiver data is stored at the connector IC device and/or at the transceiver IC device. In some embodiments, the cable and transceiver data from one end of the cable may be transmitted through the cable, using low-frequency modulation side band communication, for storage by the transceiver and cable IC devices at the opposite end of the cable. In some embodiments, the reader is operable to use historical data with newly acquired data in determining the present communication state. For example, in some embodiments the reader can retain historical data for specific, cable subsystems, and/or wirelessly access a database of historical cable communication subsystem data over a network.

In at least some embodiments, the reader is provided with diagnostic software including algorithms for determining a communication state of a cable communication subsystem, and an RFID reader to wirelessly read the data stored on the cable and/or transceiver, without disturbing communication operations through the cable subsystem. Cable subsystem operational states that may be determined (including stochastically inferred) by algorithms using the stored physical layer data include the following non-limiting examples: broken connection, broken fiber, degraded fiber, failed laser transmitter, failed p-i-n diode, low received signal, marginal received signal, removed or partially engaged connector, data rate length violation, tap applied to cable. Changes to a cable subsystem communication state can at least in some embodiments, be dynamically determined, for example in real-time.

Exemplary readers include an output device such as a display screen and/or other visible or audible signal device, for communicating the presently determined communication state of a cable subsystem to a local human user of the reader. In many circumstances, a plurality of connector/transceiver connections will be arranged in close physical proximity to one another on a network device. In such cases, all connector IC device transponders presently sensed by a reader can, for example, be displayed by the reader to enable selection of a desired cable subsystem by a user. In some implementations, at least one cable connector comprises a hand operated push button or other locally activatable mechanism that causes the connector IC device to indicate a condition and/or change in condition that can be detected by the reader, enabling a human user to more easily select a desired cable subsystem to read. At least some embodiments of the invention facilitate the presentation, for example in real time, of a detailed assessment of physical layer characteristics of a selected cable subsystem, locally of the cable subsystem and in real time.

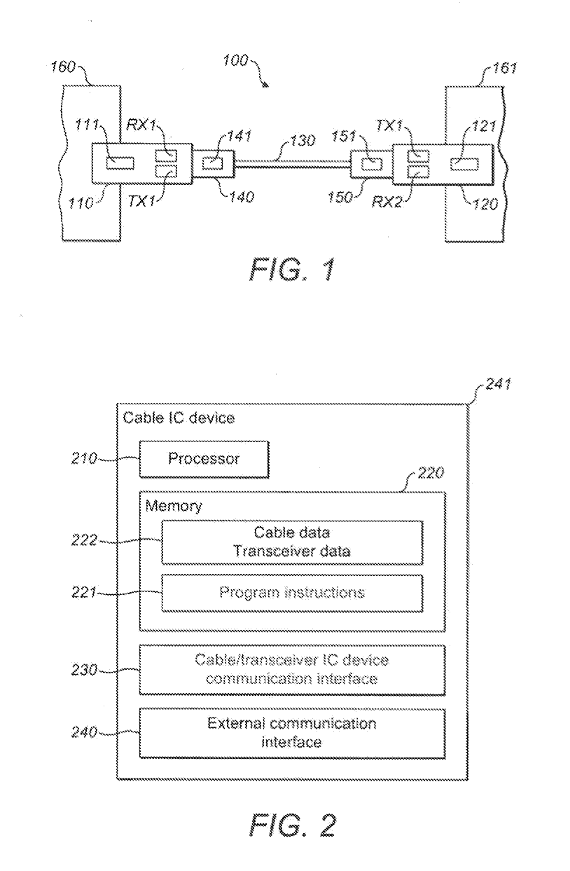

FIG. 1 shows an exemplary cable communication subsystem 100 comprising first and second transceivers 110, 120 and a cable 130. The cable 130 comprises two multimode optical fibers and is terminated at opposite ends thereof by respective cable end connectors 140, 150. The cable end connectors 140, 150 connect respective opposite ends of one of the optical fibers to a transmitter optical subassembly (TOSA) TX1 of the first transceiver 110 and a receiver optical subassembly (ROSA) RX2 of the second transceiver 120, and respective opposite ends of the other optical fiber to a TOSA TX2 of the second transceiver 120 and a ROSA RX1 of the first transceiver 110.

The cable 130 comprises respective integrated circuit (IC) devices 141, 151 attached at opposite ends portions of the cable 130, for example integrally mounted to the respective connectors 140, 150. The transceivers 110, 120 comprise respective IC devices 111, 121. The IC devices 111, 121, 141, 151 form part of a low power, low-frequency cable subsystem monitoring and/or diagnostic data communication channel. The transceivers 110, 120 are mounted, for example hot plugged, to respective network devices 160, 161 such as, for example, Fiber Channel switches, storage disk array controllers, tape library controllers and/or servers or host computers, to enable the network device 160, 170 to control high power, high-frequency communication signals through the transceivers 110, 120.

In some embodiments, the transceivers 110, 120 are operable to provide a low-frequency digital modulation side band communication channel for communicating diagnostic data between the transceivers 110, 120 through the cable 130, as disclosed for example in co-pending U.S. patent application Ser. No. 12/241,945, incorporated herein by reference in its entirety. Using the side band channel data, can be transferred between the transceiver IC devices 111, 121 at opposite ends of the cable 130. In some embodiments, transceivers 110, 120 and connectors 140, 150 can be adapted to dynamically provide cable attenuation data, for example from an optical time domain reflectometer (OTOR) embedded in a transceiver 110, 120, as disclosed for example in co-pending International patent application number PCT/US2009/062709, incorporated herein by reference in its entirety. Transceivers 110, 120 and connectors 140, 150 can also be mutually adapted to provide a mechanism that generates connector engagement status data, indicating, for example, whether a connector, is fully engaged, partially engaged or not engaged in a transceiver.

FIG. 2 shows selected functional elements of an exemplary IC device 241 that can be used as a cable IC device 141, 151. The IC device 241 has circuitry that provides a processor 210 and memory 220. The memory stores computer program instructions 221 for providing at least some of the functionality of the IC device 241 when executed by the processor 210, and stores data 222 relating to physical layer characteristics of the cable subsystem 100. The data 222 comprises cable-related physical layer parameters, for example cable serial number, cable type, connector type, and cable attenuation data captured for example during cable assembly. The data 222 can also comprise transceiver-related physical layer parameters received from a transceiver into which the cable is plugged, for example transceiver serial number, transceiver type, and include performance data relating to a quality of communication, such as optical transmit power, optical receive power, embedded OTDR attenuation data.

The cable IC device 241 also implements a cable/transceiver IC device communication interface 230 and an external communication interface 240. In at least some embodiments, the IC device 241 comprises a specially adapted RFID (radio frequency identification) tag, and the external communication interface 240 comprises an RFID transponder, for example including a parasitic power circuit. The connectors 140, 150 in some embodiments comprise a mechanism that is locally activatable by, for example a technician, to select a desired cable subsystem. The mechanism may comprise, for example a hand operated button, touch sensitive device, or any other suitable arrangement. Activation of the mechanism may cause an electrical signal to be sent to the cable IC device 241 to indicate the selection. In response to receipt of such an electrical signal, the IC device 241 may for example, cause an RFID transponder of the external communication interface 240 to communicate data indicative of such selection when interrogated, or may activate an inactive transponder.

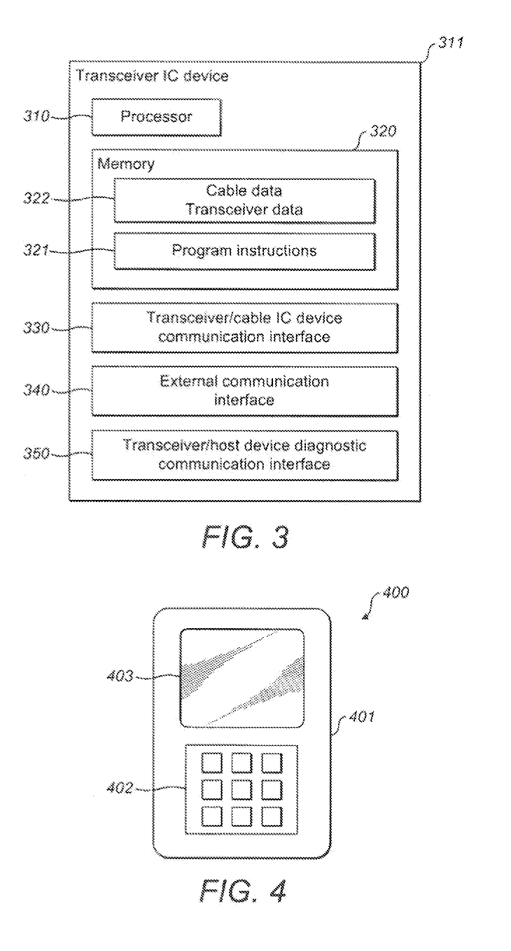

FIG. 3 shows selected functional elements of an exemplary IC device 311 that can be used as a transceiver IC device 111, 121. The IC device 311 has circuitry that provides a processor 310 and memory 320. The memory stores computer program instructions 321 for providing at least some of the functionality of the IC device 311 when executed by the processor 310, and stores data 322 relating to physical layer characteristics of the cable subsystem 100. The data 322 comprises transceiver-related physical layer parameters, for example transceiver serial number, transceiver type, and includes performance data relating to quality of communication, such as optical transmit power, optical receive power, embedded OTDR attenuation data. The data 322 in some embodiments also comprises cable-related physical layer parameters received from a cable plugged into the transceiver, for example cable serial number, cable type, connector type, and cable attenuation data captured for example during cable assembly.

The transceiver IC device 311 also implements a transceiver/cable IC device inter-integrated circuit communication interface 330 and an external communication interface 340. In at least some embodiments, the IC device 341 comprises a specially adapted RFID tag, and the external communication interface 340 comprises an RFID transponder including a parasitic power circuit. The transceiver IC device 311 may in some embodiments further implement a transceiver/host device diagnostic communication interface 350 for communicating the diagnostic data between the transceiver 110, 120 and a network device 160, 161 hosting the transceiver 110, 120, the network device 160, 161 having software (example: firmware) appropriately adapted to further communicate diagnostic data to a network management device.

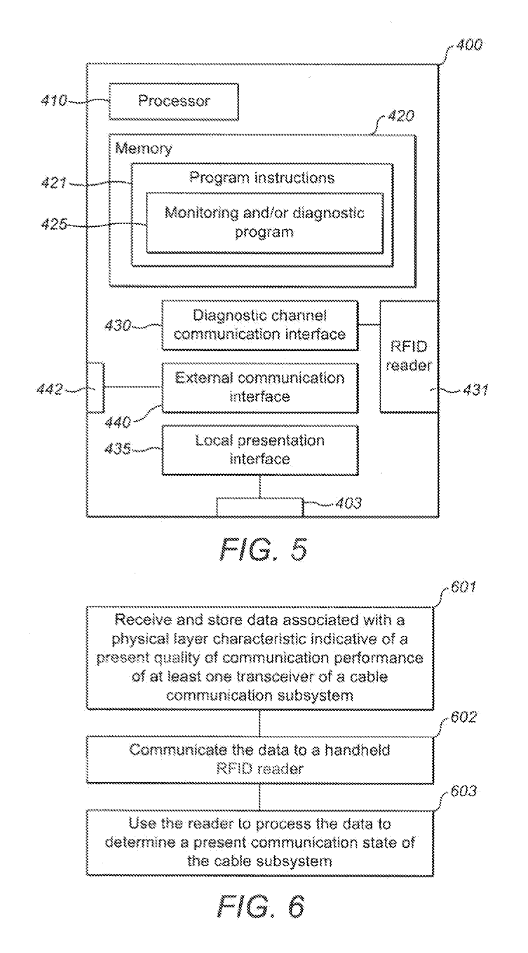

FIG. 4 shows an exemplary portable or handheld reader 400 having a casing 401 supporting at least one local input device 402, for example a keypad, and at least one local output device 403, for example a display, and/or an LED light source for providing visible output signals, and/or a sound source for providing audible output signals. FIG. 5 shows selected functional elements of the reader 400. Circuitry of the reader 400 provides a processor 410 and a memory 420. The memory 420 stores computer program instructions 421 for providing at least some of the functionality of the reader 400 when executed by the processor 410. The program instructions 421 include a cable monitoring and/or diagnostic algorithm 425 to process physical layer characteristic data 222 from a cable communication subsystem 100, and to determine a communication state of the cable communication subsystem 100.

The reader 400 also implements a diagnostic channel communication interface 430 to read cable data and transceiver data from the cable subsystem 100, and a local presentation interface 435 for providing state and diagnostic information, resulting from processing the physical layer data, in a suitable form to the output device 403. An exemplary diagnostic channel interface 430 comprises an RFID reader 431 to read the cable and transceiver diagnostic data from an RFID transponder of the cable subsystem 100. In some embodiments, the reader 400 may, implement an external communication interface 440 connected to a wireless transceiver 442 to communicate over a network, for example using IEEE 802.11x wireless LAN technology.

In at least some embodiments, the cable IC devices 141, 142 communicate with the transceiver IC devices 111, 121 using electrical contacts (not shown) that mate when a connector 140, 150 is engaged in a transceiver 110, 120. Cable data and transceiver data 222, 322 can be transferred between memories 220, 320 of the cable and transceiver IC devices 241, 311 over the electrical contacts by the cable/transceiver IC device communication interface 230 and the transceiver/cable IC device communication interface 330, for example using an inter-integrated circuit protocol such as I2C, or any other convenient protocol. The cable and transceiver data 222, 322 can be formatted in memory 220, 320 and processed by the transceiver 110, 120 and reader 400, for example, according to any suitable protocol, for example in accordance with the SFF-8472 Specification for Diagnostic Monitoring Interface for Optical Transceivers, extended as necessary to accommodate the desired physical layer parameters.

The transceivers 110, 120 in some embodiments comprise SFP+, SFP and/or SFF transceivers, or any other suitable type of transmitter and/or receiver, including those for transmitting and/or receiving electrical communication signals. While a dual fiber multimode fiber optic cable embodiment is described, any other suitable communication cable can be employed, including other types of fiber optic cable (example: single fiber single mode cable) and electrical communication cables. The various memories 220, 320, 420 can be of any convenient and appropriate memory type, or combination of memory types, including EEPROM, flash memory and particularly for the reader 400, RAM and ROM. At least some of the memory 220, 320 shown in FIGS. 2 and 3 as integrally provided by circuitry of the IC devices 241, 311, can in some embodiments be provided separately and connected to the IC devices 241, 311.

In accordance with at least one embodiment, a method is provided comprising receiving and storing in a memory data associated with at least one physical layer characteristic indicative of a present quality of communication performance of a transceiver 110, 120 connected to one end of a cable 130 of the cable subsystem (step 601, FIG. 6). The memory is associated with an IC device of the cable communication subsystem 100, for example provided on or connected to the cable IC device 241. The IC device comprises an RFID transponder. The data is communicated from the memory to a handheld RFID reader 400 (step 602, FIG. 6). The reader 400 is used to process the physical layer characteristic data to determine a present communication state of the cable subsystem 100.

For example, in some embodiments the cable subsystem 100 comprises transceivers 110, 120 respectively connected to connectors 140, 150 of a cable 130, the transceivers and cables being equipped with respective IC devices 111, 121, 141, 151 and capable, of diagnostic sideband communication. Data is exchanged between memories 220, 320 of the connector and transceiver IC devices 241, 311. Each cable memory 220 stores data relating to present transceiver communication performance for the transceivers at each end of the cable 130, for example, optical transmit power, optical, receive power, OTDR, and/or connector engagement status data at both cable ends. Each cable memory 220 also stores identity data such as transceiver serial numbers from both cable ends, and a cable serial number, in addition to other data that may be useful for monitoring and/or diagnostic purposes such as fiber type and length, core diameter and/or cable end connector type.

In at least some embodiments a user of the reader 400, such as a technician, brings the reader 400 within RFID reading distance of a cable IC device 241. In some embodiments, the user selects a cable, for example using an activation mechanism of a connector 140, 150 as described above, and the selection activates an RFID transponder of the external communication interface 240 to enable the reader 400 to read at least some of the cable data and transceiver data 222 stored on the cable IC device 241. Alternatively, all transponders may be active, and the reader displays a list of present cables and enables the user to select which to read. The diagnostic channel communication interface 430 of the reader 400 and external communication interface 240 can use any suitable protocol for transferring the data, for example LLRP (Low-Level Reader Protocol).

The reader 400 stores the received data 222 in memory 420, and executes the monitoring and/or diagnostic program instructions 425. For example, the instructions 400 execute algorithms that use the received data 222, including present transmit and receive power at both transceivers, to accurately determine the present communication state of the cable subsystem. The algorithms in some embodiments access historical data for the cable subsystem to increase accuracy. The historical data can be stored in a database on the reader 400 in memory 420, or in a separate memory. The database may in some embodiments be accessed remotely, for example from a management server, using the reader 400 external communication interface 440 and wireless transceiver 442.

The results of the processing are, output, for example a summary of the results of the processing is presented locally to the user of the reader 400 in natural language using the display 403. The initial summary may be, for example, one of three conditions: good, degraded or failed. If a degraded or failed state is determined, the exemplary executing monitoring and diagnostic instructions 425 also perform diagnosis using the received data 222, and cause the reader 400 to provides the user with an option to display diagnosis. The diagnosis can also be provided in natural language. The richer the data, the more accurate the diagnosis is likely to be. Thus, providing data from both ends of a cable, transmit and receive power, and OTDR and connector engagement data each assists accuracy of diagnosis.

At least some embodiments of the invention facilitate inexpensively, quickly and non-disruptively obtaining the status of a cable subsystem during operation, and locally presenting consequential detailed diagnostic information if necessary. According to at least some embodiments, real-time transceiver performance parameters can conveniently be obtained from a transceiver for monitoring and/or diagnostic processing using wireless (including RFID) devices. Various embodiments enable the communication performance parameters to be conveniently combined with identity parameters of transceivers and connectors of a cable subsystem.

Real time means that the time taken to perform or initiate an action is sufficiently short to be perceived by a human user as adequate to enable a timely and appropriate response consequent to the action, and can vary depending on the requirements surrounding different types of actions.

Methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps may be added, some blocks/steps removed, or the order of the blocks/steps altered and still be within the scope of the invention. Further, specific numerical data values (such as specific quantities, numbers, categories, etc.) or other specific information should be interpreted as illustrative for discussing exemplary embodiments. Such specific information is not provided to limit the invention.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A portable reader operable to read, from a memory associated with an integrated circuit (IC) device of a cable communication subsystem, data associated with at least one physical layer characteristic related to quality of communication performance of the subsystem; and to process the physical layer characteristic data to determine a communication state of the cable communication subsystem.

2. The reader of claim 1, wherein the memory and the IC device are attached to a cable of a cable communication subsystem

3. The reader of claim 1, wherein the IC, device comprises an RFID transponder tag.

4. The reader of claim 1, comprising a communication state determination algorithm, and operable to process the data using the algorithm, and to output the results of the processing.

5. The reader of claim 1, wherein the IC device and memory are integrated in a cable end connector.

6. The reader of claim 1, wherein at least some of the data comprises present cable subsystem communication performance parameters, including transmitter and/or receiver power parameters, and/or cable degradation parameters.

7. The reader of claim 2, wherein at least some of the data relates to at least one transmitter and/or receiver device connected to at least one end of a cable, and comprises at least one of: laser transmit power, laser transmit current, photodiode receive power, embedded OTDR optical signal attenuation.

8. The reader of claim 1, further operable to read from the memory data relating to identifiers of at least one of cables, connectors, and transceivers.

9. The reader of claim 1, further operable to output the communication state using at least one of: representations on a visual display screen; visible signals; audible signals.

10. The reader of claim 1, wherein the stored data relates to transceivers connected to respective opposite ends of a cable.

11. The reader of claim 1, operable to read the data from the memory without disturbing normal communication operations of the subsystem.

12. A method comprising receiving and storing in a memory associated with an RFID transponder of a cable communication subsystem, data associated with at least one physical layer characteristic indicative of a present quality of communication performance of at least one transceiver connected to an end of a cable of the cable subsystem; communicating the data from the memory to a handheld RFID reader; and using the reader to process the physical layer characteristic data to determine a present communication state of the cable subsystem.

13. The method of claim 12, comprising using the RFID reader to present results of the processing to a human user.

14. The method of claim 12, comprising processing the physical layer characteristic data in real time using a communication state determination algorithm executing on the reader, and outputting the results of the processing.

15. The method of claim 12, wherein the data includes data relating to a transceiver connected to an opposite end of the cable, and/or identity data.

16. A handheld reader operable to read, from a memory associated with an RFID device attached to a cable of an optical fiber cable communication subsystem, data associated with at least one physical layer characteristic related to present quality of cable subsystem communication performance including at least one transceiver power parameter and/or cable degradation parameter; to process the physical layer characteristic data to determine a communication state of the optical fiber cable communication subsystem; and to present results of the processing for a human user.

17. The reader of claim 16, further operable to read from the memory data relating to an identity of at least one cable, connector, and/or transceiver of the cable subsystem.

18. The reader of claim 16, further operable to present results of the processing using a visual display screen, and/or visible or audible signals.

19. The reader of claim 16, wherein the reader is operable to read the data from the memory without disturbing normal communication operations of the subsystem.

20. The reader of claim 16, comprising a communication state determination algorithm, and operable to process the data using the algorithm, and to locally present the results of the processing for use by a human user of the reader.
